(19) United States
(12) Patent Application Publication
(10) Pub. No.: US 2011/0192191 A1
(43) Pub. Date: Aug. 11, 2011

(54) HIGH PRESSURE PHYSICAL ABSORPTION PROCESS FOR USE IN CARBON CAPTURE IN ENERGY PRODUCTION PROCESSES

(76) Inventors: Cyril Timminns, Solihull (GB); Keith R. Tart, Sutton Colfdfield (GB)

(21) Appl. No.: 13/123,976

(22) PCT Filed: Oct. 13, 2009
(86) PCT No.: PCT/GB2009/002457

§ 371 Date: Apr. 13, 2011

(30) Foreign Application Priority Data
Oct. 14, 2008 (GB) 0818778.3
Jan. 21, 2009 (GB) 0900976.2
Apr. 24, 2009 (GB) 0907078.0
Jul. 15, 2009 (GB) 0912285.4

(51) Int. Cl. F25J 3/08; B01D 19/00; B01D 53/14

(52) U.S. Cl. 62/617; 95/165

(57) ABSTRACT

A process for at least partly regenerating a first absorption solvent stream, at high pressure, and loaded with a dissolved gaseous component X; comprising the following steps: contacting a feed gas stream with a lean second absorption solvent stream thereby producing a rich second solvent stream and a stripping gas stream that has a lower concentration of X than said feed gas stream; heating at least part of said rich second solvent stream by up to 100° C. before or during contacting it with a part of said stripping gas stream to produce a regenerated second solvent stream; and regenerating the loaded first solvent stream by contacting this stream with a further part of said stripping gas stream to yield a regenerated first solvent stream.

### TECHNICAL FIELD

The present invention relates to an improved process for the capture and disposal of carbon dioxide (CO₂) from gaseous streams produced in various energy production processes. In particular, the present invention relates to an improved physical absorption/adsorption process, primarily for the separation of carbon dioxide (CO₂), using high pressure regeneration. This allows the separation of such gas without significant loss of pressure energy; thereby allowing the reduction or elimination of greenhouse gas emissions from such energy production processes in a more energy efficient way.

Preferably, the invention is used as part of an energy conversion process such as a process for the generation of electrical power, hydrogen, synthesis gas or substitute natural gas (SNG). Alternatively, the invention may be used for many other chemical manufacturing processes that require the removal and disposal of by-product CO₂ such as coal gasification systems (for example integrated gasification combined cycle). All of the above mentioned energy conversion processes produce appreciable quantities of by-product CO₂

While the improved process may be applied to high pressure energy production processes it is also applicable to the energy efficient capture and disposal of carbon dioxide (CO₂) present in low pressure flue gas; for example as produced by conventional oil and coal fired power stations.

Thus, the present invention has the potential to significantly contribute to the urgent need to reduce global emissions of CO₂.

### BACKGROUND ART

Gas separation processes often make use of the ability of a liquid solvent to preferentially absorb particular components. Such processes normally use either a physical absorption solvent, a chemical absorption solvent or a mixture of both. Physical absorption processes are often preferred when undertaking gas separation at high pressure. Such processes rely upon differences in solubility in the physical solvent of the gaseous components being separated; these solubilities being dependent upon the temperature of the physical solvent and the partial pressure of individual gaseous components in the feed gas.

A simple physical absorption process comprises an absorption column and a regeneration stage. The physical solvent at high pressure (normally containing a low concentration of the component to be removed) is contacted with a feed gas in the absorption column; thus partly removing the component (X) to be separated. The loaded solvent leaving the gas absorption column contains dissolved component X which is subsequently largely removed in the regeneration stage. This is normally achieved by reducing the pressure of the loaded solvent so that component X is largely flashed off the solvent which, following such regeneration, is then pumped back to the top of the high pressure absorption column. Optionally, after such a flash step the solvent can be stripped (e.g. with air or steam) to further lower the concentration of X. If air is used for such stripping of the flashed solvent the product of such stripping which contains component X may be vented, while if steam is used the overheads are cooled to condense the steam and leave low-pressure component X for disposal.

Such a process inevitably yields the separated gas at a relatively low pressure. In some applications it is highly desirable that the separated gas be available without any significant loss of pressure. Notably, when a physical absorption process is used to remove CO₂ in a power generation or energy conversion process, the ability to separate CO₂ without any loss of pressure facilitates disposal of the captured CO₂ (for example by injecting the high pressure CO₂ thus separated into a depleted underground gas reservoir).

In a conventional process, which separates CO₂ at low pressure, a large and expensive CO₂ recompression stage is required. Consequently, for a power generation plant there is generally a significant power generation efficiency penalty associated with such CO₂ capture. However, such capture is highly desirable as it contributes to a reduction in global CO₂ emissions.

In both Europe and the USA attention has focussed on clean coal technology incorporating coal gasification; for example, Integrated Gasification Combined Cycle (IGCC) technologies and the capture and compression of by-product CO₂ to facilitate transport (for example by pipeline) for use in enhanced oil recovery by injection into depleting fields or for injection into depleted oil or gas reservoirs for safe storage.

Increasing global concerns over the causative effect of CO₂ emissions in world climate change have led to a variety of countermeasures such as increased investment in wind power, nuclear power, and planning for power plants that employ CO₂ capture to reduce or eliminate by-product CO₂ emissions. Many new build pulverized coal-based steam cycle power plants will suffer especially large negative impacts on costs and thermal efficiencies if, as seems likely, CO₂ capture and disposal is mandated.

The increased use of natural gas for power generation is placing pressure on supplies, which in turn leads to price increases. This has also led to proposals to construct coal-based SNG plants. Without carbon capture, such plants emit large amounts of by-product CO₂ to atmosphere and are thus also likely to be subject to regulations enforcing CO₂ capture and safe disposal.

There is typically a significant negative impact of CO₂ capture and export upon the costs and thermal efficiencies of processes that otherwise emit CO₂ to the atmosphere; such as clean coal technology power plants and SNG plants. Typically, this impact arises from the need to compress separated gaseous CO₂ from low pressure (following separation) to a pressure of around 100-150 bar (to allow transport and/or disposal underground).

A large proportion of the total man-made global emissions of CO₂ result from carbonaceous fuels that are combusted to generate electrical power. The flue gas produced in this activity is normally at near atmospheric pressure and contains predominantly nitrogen and CO₂.

While it has been proposed that such flue gas can be compressed to high pressures (typically 30-50 bar) to allow use of CO₂ absorption processes that operate efficiently at such pressures; the energy required for such recompression is very large; resulting in an unacceptable decrease in overall power generation efficiency. Furthermore, the CO₂ so separated normally requires extensive recompression owing to the use of flash regeneration in the CO₂ absorption process.

### SUMMARY OF INVENTION

An object of the present invention is to provide a solvent regeneration process that operates at near or above the pressure of the feed gas to be processed. Another object of the invention is to avoid the generation of low-pressure flash gas and so avoid the possible need of recompression. A further object of the invention is to provide a high pressure solvent regeneration process that can be used with several different absorber configurations; for example to remove CO₂ in an energy conversion process.

In one aspect the invention comprises a process for at least partly regenerating a first absorption solvent (A) stream loaded with a component X; comprising the following steps: (a) contacting a feed gas stream with a lean second absorption solvent (B) stream thereby producing a rich second solvent (B) stream and a stripping gas stream that has a lower concentration of X than said feed gas stream; (b) heating at least part of said rich second solvent (B) stream by up to 100° C. before or during contacting it with a part of said stripping gas stream to produce a regenerated second solvent (B) stream; and (c) regenerating the loaded first solvent (A) stream by contacting this stream with a further part of said stripping gas stream to yield a regenerated first solvent (A) stream.

During step (b) the rich second solvent stream is preferably heated by up to 30° C.; and preferably by up to 60° C.

Preferably, the first loaded solvent stream and/or the rich second solvent is regenerated at a pressure in the range 10 to 100 bar. Preferably, the feed gas is contacted with said second solvent at a pressure in the range 10 bar to 100 bar, or 25 bar to 100 bar.

Typically, one or more of steps (a), (b), (c) are carried out using contactors that comprise a counter current flow contacting column. In such cases said contacting column may comprise plates or mass transfer packing elements. However, other types of mass transfer contacting device may be used.

Said regenerated first solvent stream may be contacted with a gas stream rich in X to yield a gas stream with a reduced concentration of X and a first solvent stream rich with a dissolved component X from which said first solvent stream loaded with component X is derived. The first solvent stream rich in X may be heated, without depressurization, by a temperature up to 120° C. (and preferably up to 80-100° C.) to produce the partly regenerated first solvent stream loaded with component X and a gas stream rich in X. In addition, the first solvent stream rich in X may be pumped to a substantially higher pressure before being heated. This substantially higher pressure preferably corresponds to a pressure increase in the range 2 to 50 bar, and preferably in the range 5-25 bar.

Said regenerated first solvent stream may be contacted with a gas rich in X to yield a gas stream with a reduced concentration of X and a first solvent stream rich with a component X to which said first solvent stream loaded with component X corresponds and where the gas stream rich in X is provided by taking at least part of the gas produced by the regeneration steps (b) and/or (c) and partly removing component X by liquefaction.

The component X may comprise CO₂, H2S, COS, SO₂ or a mixture thereof.

Preferably, the first solvent (A) and second solvent (B) are the same solvent. The first physical absorption solvent (A) and/or the second physical absorption solvent (B) may include: for example; (1) dimethyl ether of polyethylene glycol (Selexol™ process); (2) methanol (Rectisol™ process); (3) n-methyl pyrrolidone (Purisol™ process): (4) polyethylene glycol and dialkyl ethers (Sepasolv™ MPE process); (5) propylene carbonate (Fluor™ Solvent process); and (6) tetrahydrothiophene dioxide (Sulfolane™ process).

In another aspect, the present invention relates to a solvent regeneration process for use within a physical absorption process that at least partly removes carbon dioxide (CO₂) from a feed gas; and in particular to a process that allows the regeneration of a physical absorption solvent at high pressure using a stripping gas derived from the feed gas itself.

Thus, the above high pressure solvent regeneration process, used within a physical gas absorption process, partly removes soluble components from a feed gas and allows the regeneration of a first physical absorption solvent at high pressure using a stripping gas derived from the feed gas itself using a further absorption and regeneration step employing either the said first physical absorption solvent or a second physical solvent. The high pressure regeneration process can be used with a main absorber in energy conversion processes to allow CO₂ produced either by combustion, partial oxidation or catalytic means to be separated and exported at pipeline pressure; thus reducing greenhouse gas emissions and avoiding the need for a large CO₂ gas compressor

It is also an object of the present invention to provide an improved method for the capture and disposal of carbon dioxide for use in high pressure chemical and energy conversion process.

One aim of the current invention is to eliminate this costly CO₂ gaseous compression step. Another aim is to provide a simpler process that allows CO₂ capture in chemical and energy conversion processes. A further aim is to largely alleviate the above mentioned negative impact of CO₂ capture and export upon the overall costs and energy efficiencies of such processes.

In one aspect the invention comprises a process for removing CO₂ from a feed gas with the following steps: (a) chilling at least part of said feed gas, at a pressure of at least 10 bar to condense and partially remove CO₂ as a liquid at high pressure for export and thereby produce a CO₂-lean gas stream; (b) passing at least part of said CO₂-lean gas stream to a contactor where further CO₂ is removed, by absorption in a solvent stream lean in CO₂ to produce a product gas stream and a solvent stream rich in CO₂ ; and (c) passing said solvent stream rich in CO₂ to a high pressure regenerator where the solvent is stripped with a stripping gas to produce a CO₂ rich gas stream at pressure and a CO₂-lean solvent stream; from which said solvent lean in CO₂ is subsequently derived.

Preferably, the process further comprises at least partly regenerating the solvent stream rich in CO₂ at high pressure (without expansion) by heating this stream by up to 100° C. before or during contacting it with a part of said stripping gas stream.

Preferably, at least part of the said CO₂ rich gas stream is mixed with said feed gas prior to step (a) and thus recycled. The stream rich in CO₂ may be heated prior to or within said regenerator.

The contactor and/or high pressure regenerator may comprise a counter current flow contacting column; for example having plates or mass transfer packing elements. The solvent may be organic or may be water-based. In the latter case, the contactor may also act as a saturator by means of which steam is added to the product gas stream, or the high pressure regenerator may act as a gas saturator by means of which steam is added to the stripping gas passing through the high pressure regenerator.

The high pressure regenerator may also comprise a counter current flow column; for example having plates or mass transfer packing elements. The high pressure regenerator may also comprise a flash vessel or series of flash vessels, where the solvent stream rich in CO₂ may also be heated. The high pressure regenerator may also comprise known mass-transfer means. The loaded stripping gas exiting the high pressure regenerator may have a CO₂ content in the range 10 to 90 mole % on a dry basis; preferably 20 to 80 mole % on a dry basis and most preferably 30 to 70 mole % on a dry basis.

The feed gas stream may be derived from raw fuel gas produced by the gasification of a carbonaceous material at a pressure in the range 10 to 150 bar, and more preferably 25 to 60 bar. Optionally, the raw product gas may undergo crude CO-shift conversion and/or purification prior to providing feed gas for the invention.

Preferably, step (a) chills gas to a temperature not lower than minus 56° C. and more preferably to a temperature in the range minus 10° C. to minus 40° C., and most preferably to a temperature in the range minus 20° C. to minus 30° C.

Preferably, the process further comprises a single stage or multiple stage expansion-compression refrigeration plant that provides at least part of said chilling during step (a) and where at least part of the cold in the condensed liquid is used to chill a refrigerant stream used in the refrigeration plant prior to expansion in at least one stage of the refrigeration plant.

In another aspect the invention comprises a process for removing CO₂ from a feed gas with the following steps: (a) chilling at least part of said feed gas, at a pressure of at least 10 bar to condense and partially remove CO₂ as a liquid at high pressure for export and thereby produce a CO₂-lean gas stream; (b) passing at least part of said CO₂-lean gas stream to a contactor where further CO₂ is removed, by adsorption on or in a substrate, thereby producing a CO₂-loaded substrate and a product gas stream; and (c) regenerating said CO₂-loaded substrate by heating the substrate and stripping the substrate with a stripping gas to produce a CO₂ rich gas stream at pressure and a CO₂-lean substrate; from which said substrate is subsequently derived. Preferably, at least part of the said CO₂ rich stream is mixed with said feed gas prior to step (a) and thus recycled. The stream rich in CO₂ may be heated prior to or within said regenerator.

It is also an aim of the present invention to provide a process for removal of CO₂ from flue gas produced by conventional coal and oil fired power stations and also generate sufficient shaft power not only to meet all of the compression requirements but also generate additional power. A further aim is to provide such a process where the additional power is generated efficiently such that the overall power generation efficiency is acceptable.

In one aspect the invention comprises a process for separating CO₂ from a (main) flue gas, produced by the combustion of a fuel, which also generates shaft power comprising the following steps: (a) compressing said flue gas and at least part of the cooled flue gas of step (e), to a pressure of at least 6 bar, to form a compressed mixed flue gas stream; (b) removing at least 60% of the CO₂ in the compressed mixed flue gas stream using a gas separation process to yield a low CO₂ content gas at a pressure of at least 5 bar; (c) heating said low CO₂ content gas indirectly using a fired heater fuelled by the combustion of a carbonaceous fuel; (d) expanding the heated low CO₂ content gas produced by step (c) in a gas turbine to yield shaft power; and (e) cooling the flue gas produced by combusting said carbonaceous fuel in step (c).

Preferably, the gas separation process of step (b) uses a physical absorption solvent.

Preferably, the gas separation process of step (b) uses a liquid solvent to remove CO₂ by absorption and so produce a loaded solvent; and where at least 30 to 70% of the loaded solvent is regenerated at a pressure of at least 5 to 15 bar. Preferably, the loaded solvent is regenerated at a pressure of at least 15 to 30 bar or 25 to 50 bar.

Preferably, in step (a) the flue gas and at least part of the cooled flue gas of step (e), is compressed to a pressure of at least 15 to 30 bar or 25 to 50 bar, to form the compressed mixed flue gas stream.

Preferably, after step (c) a fuel gas is injected into the heated low CO₂ content gas and combusted therein to further raise the temperature of the resulting stream, prior to step (d).

Preferably, the heated low CO₂ content gas used in step (d) is partly expanded in a first gas turbine to yield shaft power; and then reheated indirectly using the fired heater of step (c) or a separate fired heater fuelled by a carbonaceous fuel, prior to further expansion in said first gas turbine or a separate second gas turbine to yield additional shaft power. Preferably, after the partly expanded gas is reheated a fuel gas is injected therein and combusted therein to further raise the temperature of the resulting stream, prior to step (d). Preferably, the temperature of said resulting stream is in the range 800-1500° C., and more preferably 800-1000° C.

Preferably, during step (c) the low CO₂ content gas is heated to a temperature in the range 600 to 800° C.

Preferably, at least part of the loaded solvent is directly, or after partial regeneration, expanded to substantially atmospheric pressure and stripped with air to produce a regenerated solvent and where said air loaded with stripped CO₂ is used at least in part as oxidant in the production of said (main) flue gas. Preferably, after stripping with air the regenerated solvent is pumped to substantially the same pressure as the solvent prior to expansion.

Preferably, at least part of the loaded solvent is directly, or after partial regeneration, expanded to substantially the pressure at which the fired heater (combustor) operates, stripped with combustion air to produce a regenerated solvent and said combustion air loaded with stripped CO₂ is used at least in part as oxidant in the production of said (main) flue gas. Preferably, after stripping with said air the regenerated solvent is pumped to substantially the same pressure as the solvent prior to expansion. This is particularly advantageous with pressurized combustors, for example; pressurized fluidized bed combustors.

### BRIEF DESCRIPTION OF DRAWINGS

The invention will now be described by reference to the following simplified process flow diagrams in which:

FIG. 1 shows the main features of a basic solvent regeneration process according to the present invention;

FIG. 2 shows a preferred embodiment of the invention where the process uses a single absorption solvent;

FIG. 3 shows a complete gas separation process that uses the regeneration process of FIG. 2;

FIG. 4 shows another embodiment of the invention which includes a gas liquefaction stage;

FIG. 5 is an overall block flow diagram for a further embodiment of the invention;

FIG. 6 is a simplified process flow diagram, showing the main items only of the absorption and desorption units;

FIG. 7 is a simplified process flow diagram for a further embodiment of the invention showing the main items only of the adsorption and desorption units;

FIG. 8 is a derivative of the process shown in FIG. 7 applicable where a single solvent is used;

FIG. 9 is a simplified process flow diagram, showing the main items only of the cryogenic unit for another embodiment of the invention;

FIG. 10 shows a simplified process flow diagram for a process employing at least two adsorption towers that operate in a cyclic manner in order to adsorb and desorb CO₂.

FIG. 11 is a simplified block flow diagram for a process according to a further embodiment of the invention;

FIG. 12 is a simplified block flow diagram for a process according to another embodiment of the invention; and

FIG. 13 shows an embodiment of the invention that allows the CO₂ removal step and the gas turbine expander(s) to be operated each at their optimal pressure.

### DETAILED DESCRIPTION OF THE INVENTION

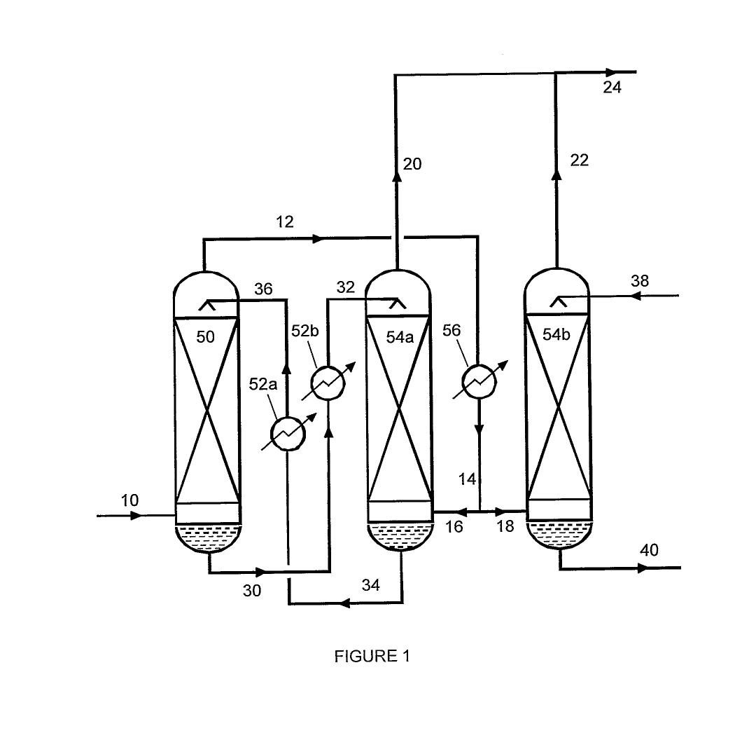

The basic high pressure solvent regeneration process will be described by reference to FIG. 1. The process accepts a loaded high pressure solvent stream (38) from a main gas absorber (not shown) and provides a regenerated first solvent stream (40) for return to the main gas absorber. Stream 38 will typically have been provided by partly regenerating a rich solvent from said main absorber without using pressure reduction; but rather by raising the temperature of said loaded first solvent. Alternatively, said loaded first solvent may come directly from the base of the main absorber.

The loaded solvent 38 from a main absorber will typically be regenerated using stripping gas derived from a feed gas stream (10) that contains an appreciable concentration of the component (X) to be separated. For example, when X is CO₂ and the feed gas 10 may comprise a high pressure fuel gas containing between 5-65% CO₂. Gas feed 10 is first contacted with a regenerated second solvent stream (36) in a first contactor (50) to produce a much lower CO₂ containing stripper gas stream (12). Stream 12 is then normally heated in heater 56 (typically by 50-90° C.) and the heated stream 14 then split into two parts; the first part (16) is used to regenerate at least part of the loaded second solvent (30) leaving the first contactor (50) in a second contactor 54a; and all or some of the remaining part (18) is used to regenerate stream 38 in a third contactor 54b. The gaseous streams 20 and 22 leaving the second and third contactors 54a and 54b are optionally combined to form stream 24 which may then pass either directly or indirectly to a main absorption stage (not shown). In the case where stream 24 passes indirectly to such a main absorption stage there may be intermediate stages comprising for example fuel gas combustion, CO-shift conversion, methane synthesis etc. The loaded second solvent stream (30) leaving first contactor 50 is normally heated (in a heater 52b) before entering second contactor 54a. Thus, the solvent stream 30 is typically heated by 10-90° C. (preferably 10-40° C.) before entering (32) the second contactor 54a. The regenerated second solvent 34 leaving column 54a (34) is cooled in cooler 52a before re-entering (36) the first contactor 50. Typically, this cooling of between 10-100° C. (preferably 50-90° C.) is provided at least in part by combining cooler 52a and heater 52b within a single heat exchanger.

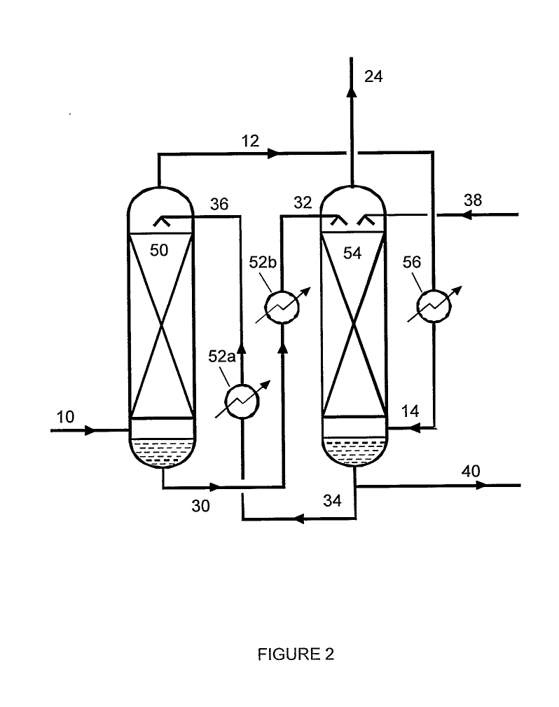

Often it will be possible and desirable to use the same physical absorption solvent in all three contactors. In this case it will often be beneficial to combine contactors 54a and 54b. FIG. 2 shows a preferred embodiment of the invention using such combined regeneration contactors. Again, the feed gas 10 is first contacted with a regenerated second solvent stream (36) in a first contactor (50) to produce a much lower CO₂ containing stripper gas stream (12) which after heating in heater 56 is used (14) to regenerate both the loaded second solvent (30) leaving the first contactor (50) and also loaded solvent stream (38) from the main absorber (not shown); this regeneration of both streams 32 and 38 taking place in a second contactor 54. Streams 32 and 38 are preferably mixed before entering the second contactor 54. The gaseous stream 24 leaving the second contactor 54 may then pass either directly or indirectly to a main absorption stage (not shown). In the case where stream 24 passes indirectly to such a main absorption stage there may be intermediate stages comprising for example fuel gas combustion, CO-shift conversion, methane synthesis etc. The loaded second solvent (30) stream leaving the first contactor 50 is heated in heater 52b before entering second contactor 54 Thus, the solvent stream 30 is typically heated by 30-90° C. before entering second contactor 54. Part of the regenerated solvent (34) leaving the second contactor 54 is chilled in cooler 52a prior to re-entering the first contactor 50. Typically, this cooling is provided at least in part by combining cooler 52b and heater 52a within a single heat exchanger. The remainder of the solvent leaving the second contactor 54 comprises regenerated main solvent stream 40 that is cooled before entering the main absorber (not shown).

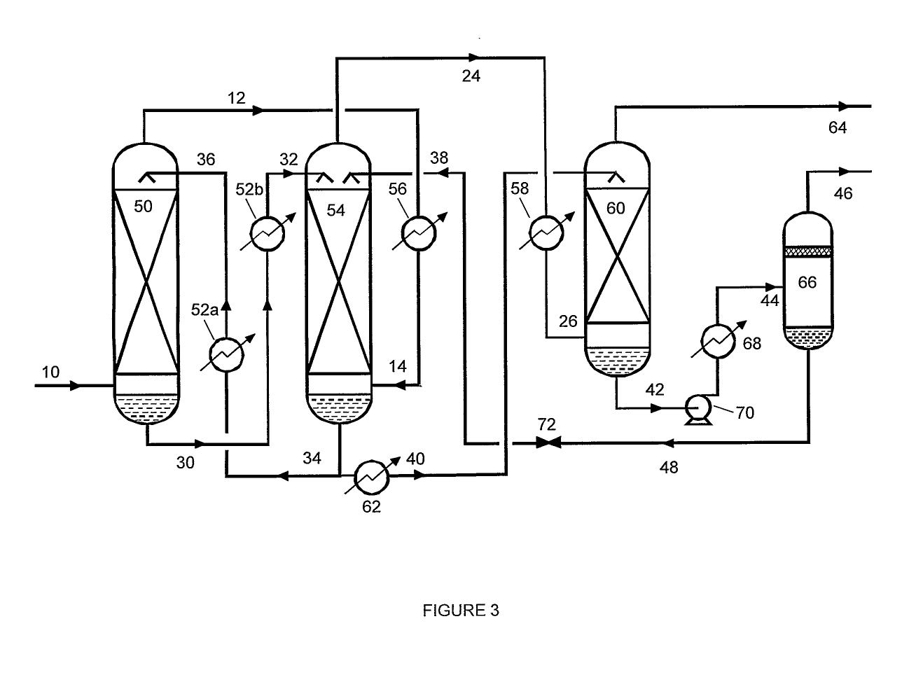

An example of a complete gas purification process using the present invention will now be described by reference to FIG. 3. In this example CO₂ is being removed from a high pressure combustion gas. The composition temperature and pressure of the labeled process streams are shown in Table 1. This example comprises the streams and contactors described earlier in reference to FIG. 2, except for the addition of heat exchangers 58, 62, 68; a main absorber 60, a gas-liquid separator (KO Pot) vessel 66, pump 70, expansion valve 72 and their associated streams 26, 42, 44, 46, 48 and 64. Thus, the gaseous stream 26 (in this case provided by cooling stream 24 in cooler 58 on leaving the second contactor 54) passes to main absorber vessel 60 where CO₂ is reduced to a low level by contacting with regenerated main solvent stream 40 thus producing a product gas stream 64 and a main absorber solvent loaded stream 42 which is optionally pumped to a higher pressure by pump 70 and then heated in heater 68 prior to entering KO Pot 66 where high pressure gaseous CO₂ (46) suitable for disposal export is separated from the liquid solvent leaving a partly regenerated high pressure solvent stream 48. Optionally, stream 48 is expanded to a pressure slightly above the operating pressure of the second contactor 54 prior to regeneration therein.

In practice, stream 10 will normally contain sulphur dioxide (SO₂). Such SO₂ is largely removed in the main absorber (60) and appears in the loaded solvent stream (42) leaving the main absorber; eventually to be released as part of high pressure CO₂ export gas stream 46. Such SO₂ can be recovered from stream 46 by known means; for example sulphite washing or distillation.

The oxygen content of stream 64 may be used to facilitate its heating; for example, by catalytic combustion using a hydrogen rich gas prior to turbo expansion to produce power. Alternatively, oxygen may be removed from stream 10 by catalytic combustion of an injected fuel. The heat so liberated may be used to heat stream 64 prior to turbo expansion. Reducing the oxygen concentration in stream 10 may be also advantageous in preventing solvent degradation.

Table 2 shows data corresponding to Table 1 for cases where the feed gas 10 comprises a fuel gas derived from the gasification of a carbonaceous feed that has undergone catalytic CO-shift conversion and been largely desulphurised. Stream 10 may contain small amounts of hydrogen sulphide (H₂S) in the order of 10 ppmv. Such H₂S is largely trapped within the rich solvent stream (42) leaving the main absorber and subsequently leaves as part of a high pressure CO₂ export stream 46. This stream will contain a maximum of about 2.5 times the inlet H₂S concentration in feed gas 10. Thus, if the inlet H₂S gas concentration (stream 10) is 10 ppmv there will be about 25 ppmv H₂S in stream 46; product gas stream 64 will contain about 1 ppmv H₂S.

Table 3 shows data corresponding to Table 1 where the feed gas 10 comprises a fuel gas that has been derived from the gasification of a carbonaceous feed and methanated using catalytic methane synthesis, respectively.

In this embodiment of the process a recycle stream of CO₂ is achieved by recycling the partially regenerated solvent stream 48 exiting KO pot 66, via stream 38 into regenerator vessel 54 where the solvent is largely stripped of CO₂ by upwardly flowing gas stream 14 to form part of the CO₂-rich outlet stream 24. It is then absorbed from said stream together with CO₂ derived from feed gas stream 10 in absorber vessel 60 to be returned in streams 42 and 44 to KO pot 66. For a given KO pot pressure the amount of CO₂ so recycled is governed by the temperature of said KO pot. Higher temperature operation reduces the recycle rate by reducing the CO₂ concentration in stream 48 while lower temperature operation increases said concentration and the recycle rate. This recycle stream of CO₂ enables a higher inlet CO₂ concentration to be maintained in rich solvent streams 42 and 44 in order to achieve the desired KO pot pressure.

It is also advantageous to cool solvent stream 48; for example against rich solvent stream 30, before reducing its pressure in order to avoid release of gaseous CO₂ during pressure reduction; for example using a hydraulic turbine.

The invention may also be used with a process where the gaseous stream 24 leaving the second contactor (54) passes through a CO₂ liquefaction stage (I-III) prior to entering a main CO₂ absorber (60).

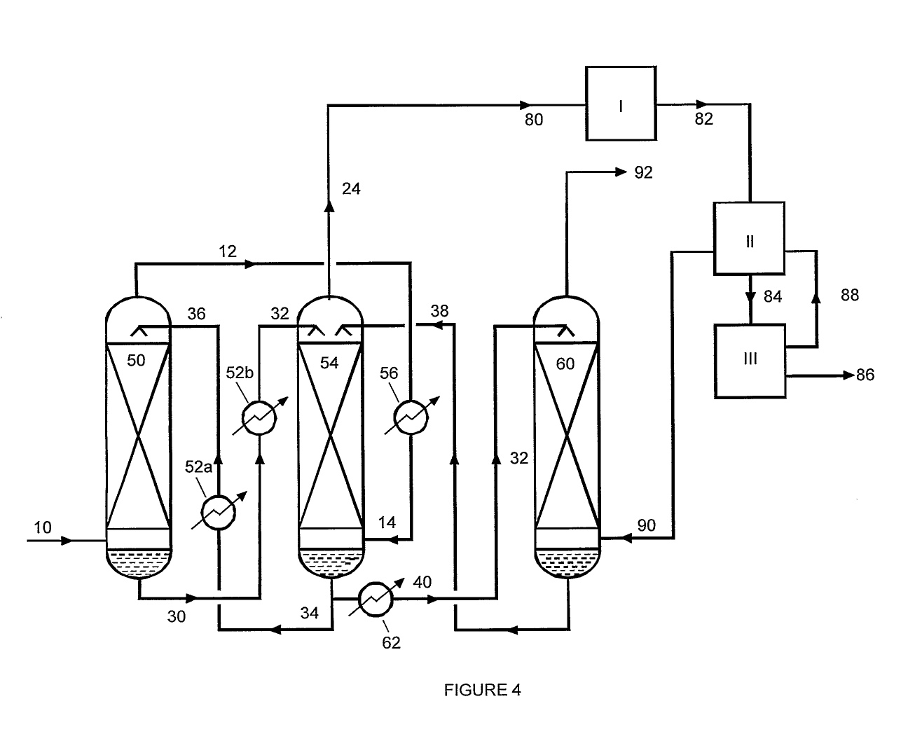

FIG. 4 shows a combined simplified flow diagram and block flow diagram for such a scheme. The equipment and streams shown in FIG. 4 are as described in FIG. 2 apart from Units I-III and related streams 80, 82, 84, 86, 88, 90 and 92. Unit I is a conventional pre-treatment unit which renders gas stream 80 fit for subsequent cooling to a low temperature and thereby allows subsequent cold recovery from this stream in downstream Unit II using conventional heat exchange art. Downstream Unit III is preferably a cryogenic separation unit equipped with refrigeration means which partly separates CO₂ by condensation, to produce a liquid CO₂ condensate stream (86) and a CO₂-lean gas stream (88).

Thus, gas stream 80 (derived directly or indirectly from stream 24) is passed to Unit I for pre-treatment to render it fit for subsequent cold processing; in particular, water vapour is removed to prevent ice formation. The treated gas 82 is then pre-cooled in unit II and the cooled stream 84 then passed to unit III where part of the CO₂ is condensed out as liquid. Cooling in unit II is achieved in part using cold exit gas from unit III and optionally liquid CO₂ from unit III. Additional external refrigeration is also normally provided. Such cooling must be limited in order to avoid solid CO₂ formation which occurs at minus 56° C. In practice, the temperature is preferably higher and in the range minus 10° C. to minus 30° C., and so the CO₂ content of the exit gas (88) lies in the range 20 to 65 percent by volume. Liquid CO₂ (86) separated in unit III is preferably pumped to a suitable pressure (a pressure of 60 bar permits warming up to 20° C.) before it is heated partly by heat exchange with treated gas in unit II and partly by exchange with warm higher pressure refrigerant from a refrigerant condenser (not shown) to sub-cool said refrigerant before it is reduced in pressure to enter a refrigerant evaporator (not shown). This ensures that no vaporization of the liquid CO₂ occurs during such heat exchange. After said heat exchange the liquid CO₂ may be pumped to supercritical pressure or higher (above 76 bar and typically 100-150 bar) and passed to an export pipeline Alternatively, the separated liquid CO₂ stream may be pumped to supercritical pressure or above prior to said heat exchange. A partly purified gas (88) with a lowered CO₂ content of typically 20-40% by volume (CO₂-lean gas) is passed to unit II for cold recovery and then passed (90) to main absorber 60 where further CO₂ is removed by solvent washing. The resulting low CO₂ product gas is stream 92. Thus, all of the CO₂ removed in the process leaves as high pressure liquid CO₂ stream 86 to be pumped and warmed as above prior to export through a pipeline.

In all of the above embodiments of the invention described by reference to FIGS. 3 and 4, solvent may be withdrawn from the main absorber 60 at an intermediate point, or points; cooled and then reintroduced it into the said absorber. This advantageously reduces the solvent temperature at the base of column 60 and thus enables an increased concentration of CO₂ in the solvent. A lowering of solvent exit to temperature by about 10° C. allows a 20% increase in CO₂ concentration in the solvent leaving the main absorber column 60.

Thus, the present invention provides a solvent regeneration process that operates at near or above the pressure of the feed gas to be processed. The present invention avoids the generation of low-pressure flash gas and so avoids the possible need of recompression. The present invention also advantageously provides a high pressure solvent regeneration process that can be used with several different main absorber configurations; for example to remove CO₂ more efficiently in an energy conversion process.

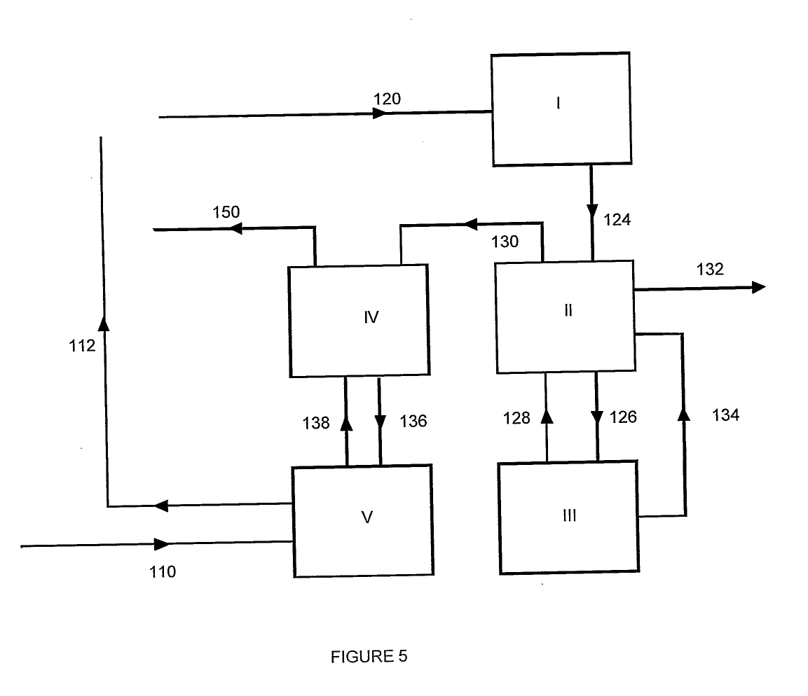

FIG. 5 is an overall block flow diagram for another embodiment of the invention. Unit I is a conventional pre-treatment unit which renders a feed gas (120) fit for subsequent cooling to a low temperature and thereby allows cold recovery in Unit II using conventional heat exchange art. Unit III is preferably a conventional cryogenic separation unit equipped with refrigeration means which partly separates CO₂ by condensation, to produce a liquid CO₂ condensate stream (134) and a CO₂-lean gas stream (128). Unit IV is a solvent wash absorption unit (contactor) where further CO₂ is absorbed using a CO₂-lean solvent; unit V is a solvent stripping unit (regenerator) where CO₂ absorbed in solvent in unit IV is desorbed by stripping the solvent with a stripping gas (110) to enable its re-use in solvent wash unit IV as regenerated (CO₂-lean) solvent. The stripping gas (110) will have a low CO₂ content and may be derived from the feed gas (see below) or may be provided by import of a suitable gas; for example nitrogen by-product from an air separation unit. The stripping gas (110) may also be a CO₂-free permanent gas whose presence in product gas stream 150 is acceptable, e.g. N₂ when product gas is to be used for NH₃ production or as Integrated Gasification Combined Cycle fuel gas, in which case stream 112 is preferably mixed with stream 120.

The feed gas (120) is passed to unit I for pre-treatment to render it fit for subsequent cold processing; in particular, water vapour is removed to prevent ice formation. The treated gas (124) is pre-cooled in unit II and the cooled stream (126) then passed to unit III where the gas is further cooled to condense out liquid CO₂. Cooling in unit II is achieved in part using cold exit gas (128) from unit III and liquid CO₂ (134) from unit III. Additional external refrigeration is also normally (optionally) provided. Such cooling must be limited in order to avoid solid CO₂ formation which occurs at minus 56° C. In practice, the lower temperature is considerably higher and in the range minus 20 to minus 30° C., and so the CO₂ content of the exit gas (128) lies in the range 20 to 40 percent by volume. Liquid CO₂ separated in unit III is pumped to a suitable pressure (a pressure of 60 bar permits warming up to 20° C.) before it is heated by heat exchange with treated gas (124) in unit II. This ensures that no vaporisation of the liquid CO₂ occurs in unit II. After leaving unit II the liquid CO₂ is pumped to supercritical pressure or higher (above 76 bar, and typically 100-150 bar) and passed (132) to an export pipeline. Alternatively, the separated liquid CO₂ stream (134) may be pumped to supercritical pressure or above prior to entering unit II. A partly purified gas (128) with a lowered CO₂ content of typically 20-40% by volume (CO₂-lean gas) is passed to unit II for cold recovery and then passed (130) to unit IV where further CO₂ is removed by solvent washing. The resulting product gas is stream (150). Then, CO₂-rich solvent (136) from unit IV is passed to unit V to be counter-currently stripped of CO₂ by a suitable stripping gas (110). Thus, only a small amount of CO₂ goes forward with product gas stream 150, the major portion being removed as liquid (134) in unit III and exported (132) via unit II.

Stripping gas (110) may also be high pressure vapour of a volatile liquid (e.g. butane) which on leaving the regenerator as stream 112 laden with CO₂ is subjected to cooling to condense out and recover the volatile liquid and leave a high pressure stream of CO₂ containing traces of said liquid. Such remaining traces of the liquid are recovered by known means e.g. solid adsorbent technology. The resulting high pressure CO₂ may be directly exported to pipeline after suitable compression, if required, or liquefied by refrigeration means and pumped to higher pressure for pipeline export.

Where such volatile liquid vapour stripping is practiced, depending on feed gas stream 120 CO₂ content, it may be preferable to eliminate units I-III of FIG. 5 and route the feed gas stream 120 direct to the absorber (unit IV) from which product gas stream 150 is then exported. Rich solvent stream 136 is then regenerated in unit V and by-product stream 112, exiting from unit V is processed as described in the above paragraph to recover the volatile liquid and produce a high pressure stream of CO₂.

The power requirement for CO₂ removal and disposal in this example of the invention is about 30 kWh per tonne of CO₂, compared with a published value of up to 150 kWh per tonne by conventional means employing solvent wash only and compression of CO₂ gas to pipeline pressure.

More Detailed Description of Units IV and V

There are many different commercial solvent wash processes for CO₂ removal as described above. In some processes it may be advantageous to add steam, directly or by saturation using hot water, to the stripping gas used in unit V. Such steam increases the volume of stripping gas, and acts as a source of heat, if required, for regeneration of the solvent. The selection of such processes is made on largely economic grounds.

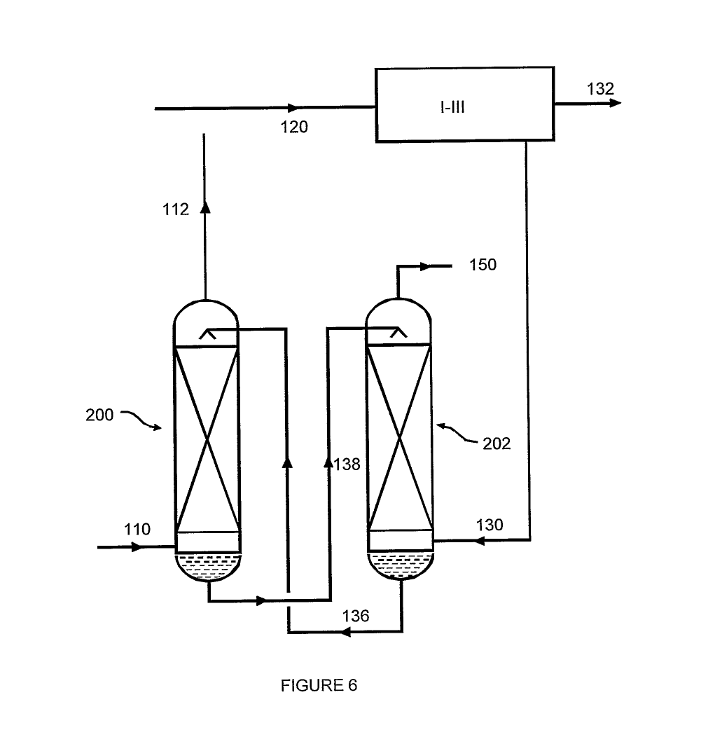

To show explicitly the method by which most of the CO₂ contained in feed gas is removed reference is made to FIG. 6, in which the numbering of block units is identical to that in FIG. 5.

Feed gas stream 120 passes to a processing train consisting of units I-III (as described above) and respectively comprise gas preconditioning, cold recovery and cryogenic separation; the latter normally employing a degree of external refrigeration. Liquid CO₂ (132), or CO₂ at supercritical conditions, is exported from unit III and the partly purified gas stream 130, typically containing 20-40% by volume CO₂, is passed to absorber column 202 (contactor) in which it is counter currently washed by the CO₂ lean solvent (138) from stripper column 200 (regenerator). The washed gas stream from absorber 202 provides product stream 150 and a CO₂ rich solvent (136) is passed from the sump of column 202 to the top of regenerator column 200 for stripping by a suitable stripping gas stream 110, having little or no CO₂ within it. The pressure of solvent circulating between the columns 200 and 202 is substantially the same as the pressure of the partly purified gas stream 130. This advantageously, results in the by-product stream 112, which contains largely CO₂ released (separated) in column 200, being at a (high) pressure very close to the pressure of stream 130.

For the sake of clarity means of pumping these solvent between absorber column 202 and stripper column 200 are not shown. Those skilled in the art will recognize that, dependent upon the CO₂ wash process employed, means of lean/rich solvent heat exchange, rich solvent heating and lean solvent cooling may be employed; and further, that for chemical absorbent solvents such as hot potassium carbonate solution, stripping gas stream 110 may have steam added to it, for example, by direct injection or by use of a hot water saturator.

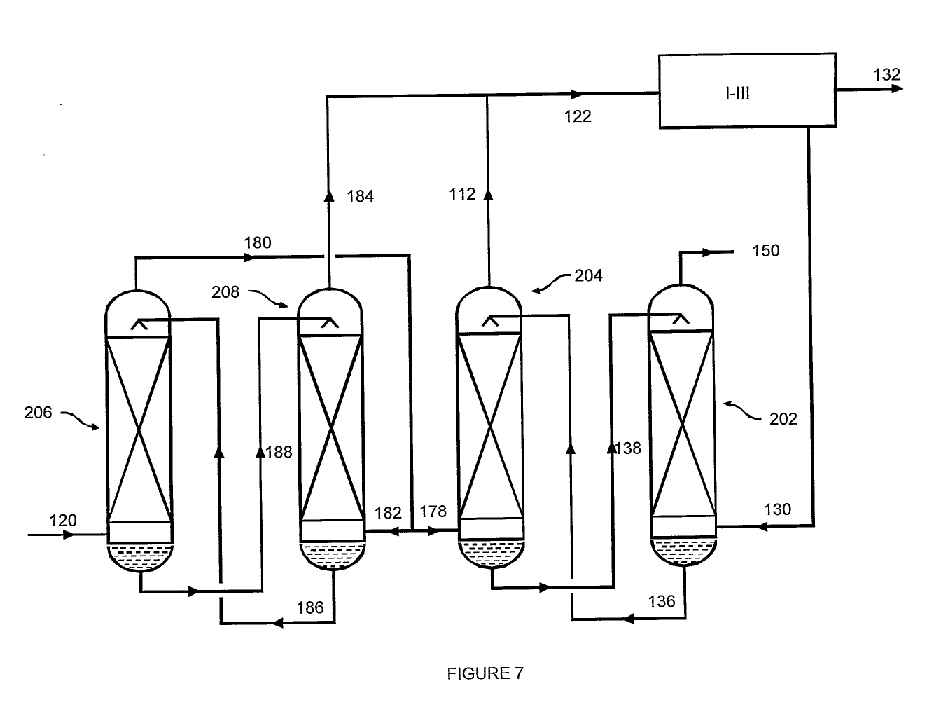

FIG. 7 shows a further embodiment of the invention that does not require the supply of an external stripping gas stream. Item 206 is a CO₂ absorption column in which the feed gas stream 120 is counter currently washed with a solvent (186). The purified low CO₂ content gas (180) from item 206 is split into two streams, 178 and 182. Stream 182 is passed to item 208, a CO₂ stripper column to counter currently strip CO₂ from CO₂ rich solvent (188), said rich solvent is being circulated between items 206 and 208 by pumping means not shown. The stream 184 leaves item 208 laden with CO_{2. CO}₂ lean solvent (186) from item 208 is returned to item 206. Stream 130 typically containing 20 to 40% CO₂ is passed to item 202 to be counter currently washed with lean solvent (138). The purified gas stream 150 is then exported. CO₂ rich solvent (136) from item 202 is passed to CO₂ stripper column 204, to be counter currently stripped by stream 178. Lean solvent (138) from stripper column 204 is returned to item 202.

Stream 112 leaving unit 204 laden with CO₂, is combined with stream 184 which exits item 108. The combined stream 122 is then passed to the processing train constituted by units I-III. Liquid CO₂ (132), or CO₂ at supercritical conditions, is exported from unit III.

In the arrangement of FIG. 7 the solubility of CO₂ in the rich solvent is decreased by raising its temperature suitably before or in items 204 and 208, to allow streams 178 and 182 to strip CO₂ adequately from a rich solvent (136,188). In the case of chemical solvents such as hot a potassium carbonate solution, steam may also be added to the stripping gas stream 178 and/or 182.

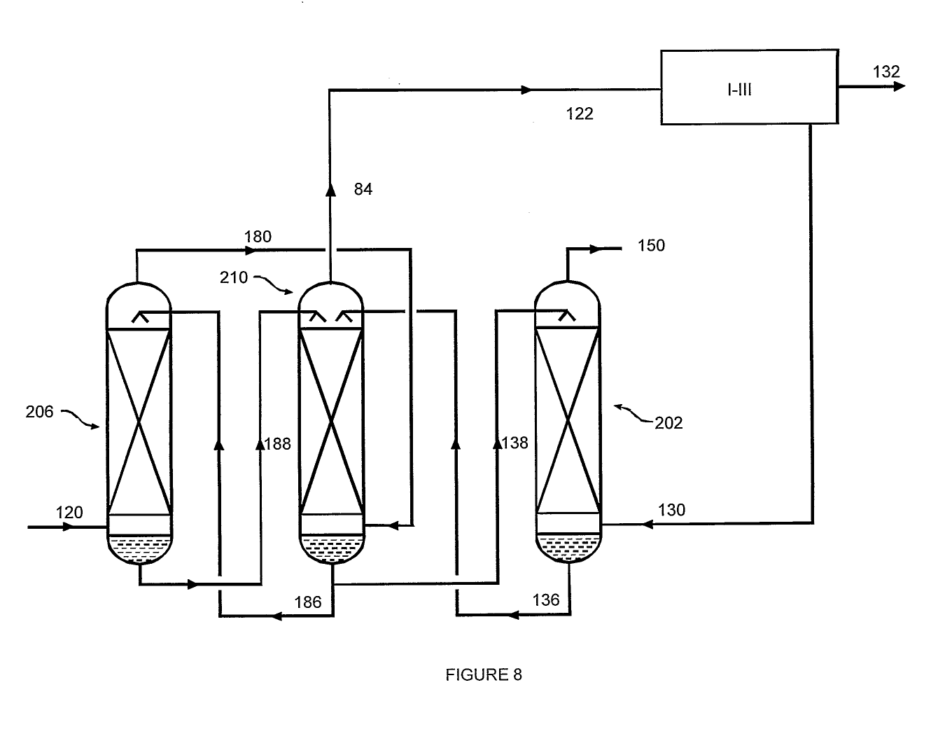

The CO₂ removal process used in items 202, 204 and 206, 208 may or may not use the same solvent. However if the same solvent is used those skilled in the art will recognize that items 204 and 208 can be combined (FIG. 8) into a single CO₂ stripper column (210), using the whole of stream 180 as stripping gas. As in FIG. 7, a solvent pumping means are not shown, nor means of solvent heating, cooling, and lean/rich solvent heat exchange.

More Detailed Description of Unit III

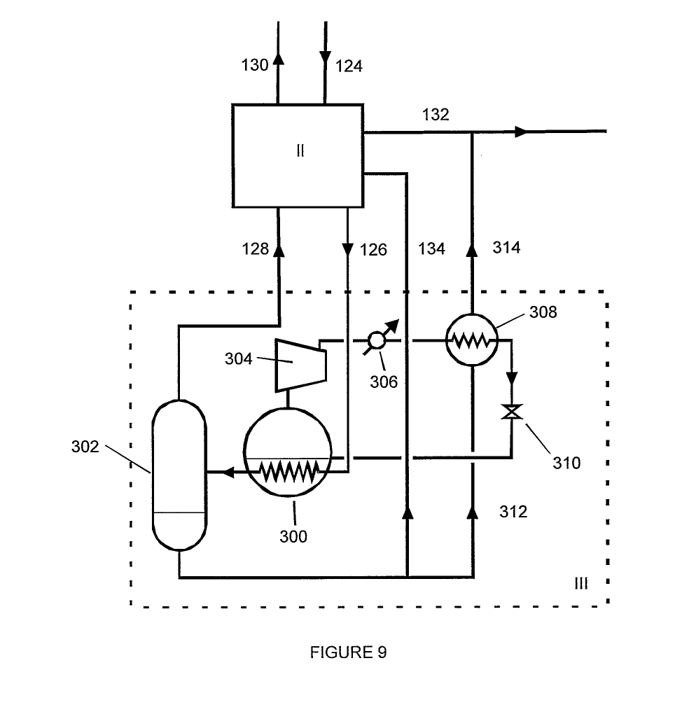

FIG. 9 shows unit III in more detail for another embodiment of the invention. Pre-treated feed gas (124) rich in CO₂ is cooled in unit II by heat exchange with cold fluids from unit III. The cooled stream rich in CO₂ (126) is then further cooled in a refrigeration evaporator (heat exchanger) 300 to partially condense out liquid CO₂; this liquid CO₂ is then separated from the gas phase in a knock-out pot 302. The separated liquid CO₂ condensate stream from pot 302 is pumped to a higher pressure (pump not shown), to avoid vaporisation in subsequent heat exchange (60 bar permits warming to 20° C.), and split into two streams (134, 312). The first liquid CO₂ stream (134) passes through unit II to recover its cold content to produce a warmed CO₂ liquid stream (132). The second liquid CO₂ stream (312) is passed through a heat exchanger 308 to sub-cool a liquid refrigerant stream from a refrigerant compressor 304. The two warmed liquid CO₂ streams (132, 314) then rejoin, and are pumped to a supercritical pressure (typically 100-150 bar), and pass to an export pipeline. Low-pressure refrigerant vapour from evaporator 300 is compressed (304) to a pressure sufficiently high to allow the refrigerant to be condensed by cooling water in a heat exchanger 306. Condensed high pressure refrigerant is then sub-cooled in heat exchanger 308 before being expanded to a lower pressure through a letdown (expansion) valve 310 and then returning to evaporator 300.

Refrigerant is evaporated in evaporator 300 at a suitable lower pressure to condense liquid CO₂ from the gas stream 126. The CO₂ lean gas stream (128) separated in pot 302 is passed through unit II to recover its cold content.

Those skilled in the art will recognize that more than one stage of refrigeration may be employed rather than a single stage as shown in FIG. 9.

Cyclic Temperature Swing Adsorption Scheme

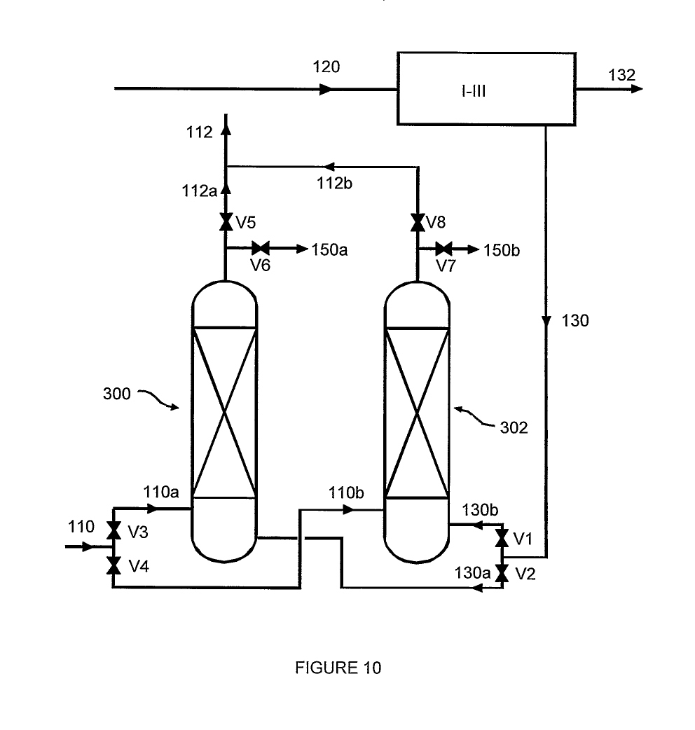

FIG. 10 shows a scheme where the absorption column (302) and desorption column (300) of FIG. 6 are replaced by at least two vessels (300,302) containing a solid capable of adsorbing CO₂ from stream 130 at a first temperature and desorbing CO₂ into stripping gas stream 110 at a second temperature that is higher than the said first temperature. The stripping gas (110) will have a low CO₂ content and may be derived from the feed gas or may be provided by import of a suitable gas; for example nitrogen by-product from an air separation unit. Preferably, vessels 300 and 302 operate cyclically and by means of valves V1 to V8. Stream 130 is first directed to vessel 302 to adsorb most of the residual CO₂ and a heated stripper gas stream (110) is passed through vessel 300 to desorb CO₂ that has previously been adsorbed from stream 130. When the adsorption capacity of the solids in vessel 302 is near saturation valves V1, V3, V5 and V7 are closed and valves V2, V4, V6 and V8 are simultaneously opened so that stream 130 is directed to vessel 300 while a heated first fuel gas stream is passed through vessel 302 to desorb CO₂ that has been previously adsorbed from stream 130. Hence, such switching of valves V1-V8 results in the flow of stream 130 being redirected to vessel 300 and the first fuel gas stream being redirected to vessel 302; the flow of product gas (150) being derived from vessel 300 (150a) instead of vessel 302 (150b); and of the flow of second fuel gas (112) being derived from vessel 302 (112b) instead of from vessel 300 (112a). Desorption takes place at a pressure close to the pressure of partly purified gas stream 130 and hence advantageously results in the separation of CO₂ at high pressure.

The skilled artisan will recognise that well known means can be employed to cool a regenerated (hot) substrate prior to its cyclic use (at lower temperature) for adsorption; for example, involving the use of an extra vessel or vessels not shown in FIG. 10.

The above temperature swing adsorption scheme thus provides a process for removing CO₂ from a process stream (feed gas) at high pressure that also exports by-product CO₂ at a similar high pressure; comprising the following steps: (a) chilling at least part of said feed gas (120), at a pressure of at least 10 bar to condense and partially remove CO₂ as a liquid (132) at high pressure for export and thereby produce a CO₂-lean gas stream (130); (b) passing at least part of said CO₂-lean gas stream to a contactor where further CO₂ is removed, by adsorption in/onto a substrate to produce a product gas stream (150) and a substrate loaded with CO₂; and (c) regenerating said substrate loaded with CO₂ by stripping with a stripping gas (110) to produce a CO₂ rich gas stream at pressure (112) and a CO₂-lean substrate, from which said substrate is subsequently derived.

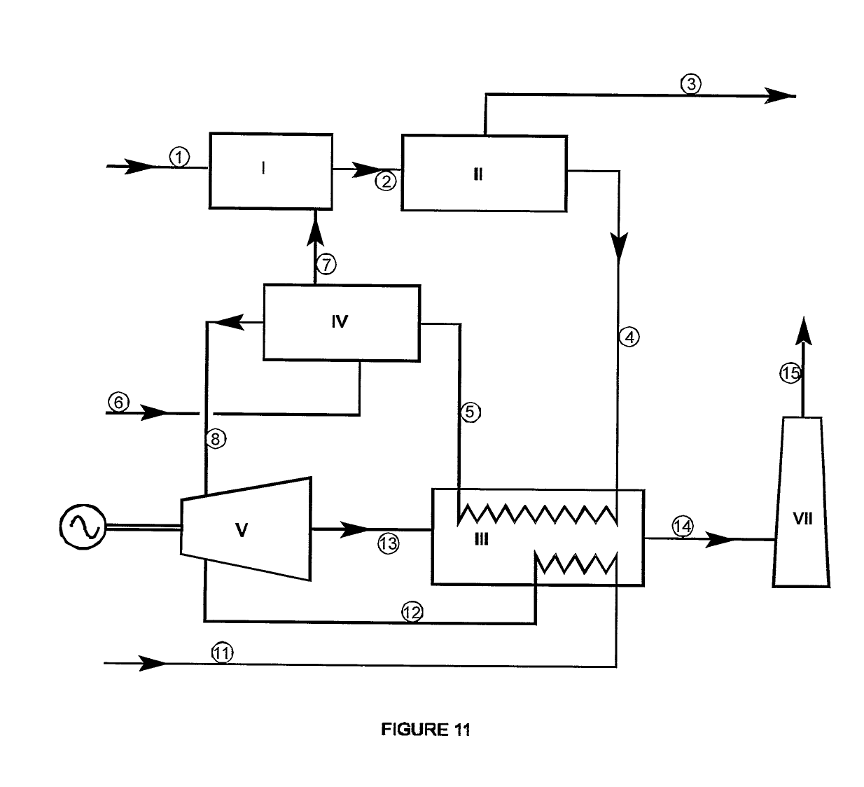

FIG. 11 is a simplified block flow diagram for another embodiment of the invention. Flue gas from a fossil fuel fired power plant is cooled to close to ambient temperature; suitable means include direct water cooling in a counter currently operated packed column; the heated water being cooled in a conventional cooling tower for return to the direct contact column. The cooled flue gas (Stream 1) typically contains about 16% by volume CO₂ and about 3% oxygen; the remainder of the gas being largely nitrogen. The flue gas is compressed to a pressure of 35 bar using a multi staged inter-cooled compressor (I). The compressor will be designed such that the flue gas is always at a temperature above its dew-point in order to avoid corrosion from acid gas components (such as SO₂) in the flue gas. Existing air compression machines can be used to compress the flue gas; suitable machines would be air compressors presently employed in large cryogenic air separation unit plants or gas turbine air compressors.

The compressed flue gas is mixed with compressed flue gas (Stream 7) from a fired heater (see below) and the mixture (Stream 2) then passed to a CO₂ removal unit (II). Because the gas is at high pressure, a wide range of CO₂ removal processes are available; in particular physical solvent processes, which (using a non-standard configuration) offer the possibility of obtaining separated CO₂ at high pressure. For example, by thermal regeneration of the solvent at a pressure of approximately 35 bar or stripping of such solvent with a low CO₂ content gas. By such means production of low pressure CO₂ flash gas, and its subsequent recompression, may be avoided. This is an advantage as it allows such CO₂ to be exported, for example by pipeline to a depleted underground reservoir, without the need for significant further compression. Additionally, many physical absorption processes are capable of removing SO₂. The CO₂ thus removed is sent (Stream 3) for compression and any required treatment e.g. SO₂ removal, dehydration etc., to render it fit for pipeline access.

A low CO₂ content flue gas (Stream 4) is indirectly heated to 200° C. using gas turbine exhaust (see below) in a fired expander exhaust duct (III) and before passing (Stream 5) to a fired heater (IV), preferably comprising a coal-fired fluidised bed combustor (FBC), where the low CO₂ content flue gas is further heated to 750° C. and passes (Stream 8) to a fired gas turbine expander (V). H₂ fuel gas (Stream 11) is indirectly heated to 200° C. in the fired expander exhaust duct and passes (Stream 12) to the fired expander (V). The heated H₂ fuel gas combusts with part of the residual oxygen contained in the flue gas and the resulting hot combustion gas at 900° C. is expanded to produce power and the turbine exhaust (Stream 13) at 250° C. enters the fired expander exhaust duct (III). Advantageously, no blade coolant gas is required for this firing temperature of 900° C. Cooled exhaust gas (Stream 14) leaves the fired expander exhaust duct at a temperature of about 100° C. and is vented (Stream 15) to via stack VII to the atmosphere. Flue gas (Stream 7) from the fired heater (FBC) is cooled and compressed to a pressure of 35 bar before admixing with compressed Stream 1 to form Stream 2 as described above. Alternatively, the cooled low pressure main flue gas feed (Stream 1) may be mixed with the cooled low pressure flue gas (Stream 7) from the fired heater and the mixed flue gas then compressed to a pressure of 35 bar. In some cases, it may be necessary to admix low CO₂ content flue gas (Stream 4) with compressed air in order to increase the oxygen content of the gas thereby assisting the subsequent combustion step in expander V.

Hydrogen fuel gas may be obtained by known processes such as natural gas steam reforming, CO-shift conversion and CO₂ removal or partial oxidation/gasification of a carbonaceous fuel followed by CO-shift conversion and CO₂ removal. Alternatively, natural gas may be used instead of hydrogen; albeit at the cost of slightly lower overall CO₂ capture.

Table 4 presents a simplified overall mass balance for this further of the invention; the cooled flue gas stream (Stream 1) corresponding to that of a typical 500 MWe coal fired power station.

The fired expander produces 425 MW, and the total flue gas compression power amounts to 258 MW, giving a net power output of 167 MW. H₂ fuel gas LHV input is 105 MW and coal input to the FBC is 396 MW, giving a total fuel input of 501 MW and a net (incremental) LHV efficiency of 33%.

Where a physical absorption process is used for removing CO₂ from the pressurised flue gas by contacting this flue gas with a regenerated physical solvent; at least part of the loaded solvent so produced may be directly, or after partial regeneration, expanded to substantially atmospheric pressure and stripped with air to produce a regenerated solvent and the air loaded with stripped CO₂ so produced being used at least in part as oxidant in the production of the main (not FBC) flue gas (Stream 1) to be treated. Further, after such stripping with air the regenerated solvent so produced may be pumped to substantially the same pressure as the solvent prior to expansion for re-use (in the absorber) in the absorption process.

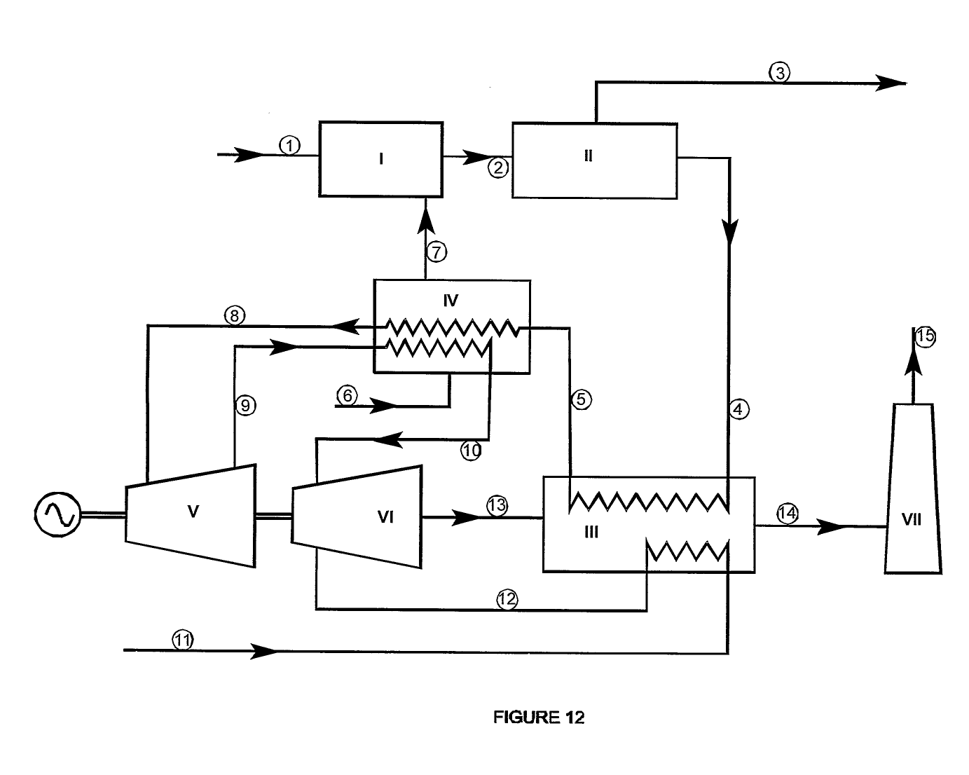

FIG. 12 is a simplified block flow diagram for another embodiment of the invention. This embodiment differs from the embodiment described immediately above only in that it uses two gas turbine expanders. Thus, units I-III and VII and streams 1-5 and 11-15 are as described above. Heated flue gas (Stream 8) at 750° C. is expanded from a pressure of 35 bar to 14.5 bar in an un-fired expander (V); the partly expanded gas (Stream 9) is then re-heated to 750° C. in the fired heater (V) and passes to a second expander (VI) to which pre-heated H₂ (Stream 12) is added. Again, the heated H₂ fuel gas combusts with part of the residual oxygen contained in the flue gas and the resulting hot combustion gas at 900° C. is expanded to produce power and the turbine exhaust (Stream 13) at 370° C. enters fired expander exhaust duct.

Table 5 presents a simplified overall mass balance for this embodiment of the invention.

The un-fired expander produces 127 MW and the fired expander 366 MW, and the total flue gas compression power amounts to 272 MW, giving a net power output of 221 MW. H₂ fuel gas LHV input is 110 MW and coal input to the FBC is 472 MW, giving a total fuel input of 582 MW and a net (incremental) LHV efficiency of 38%.

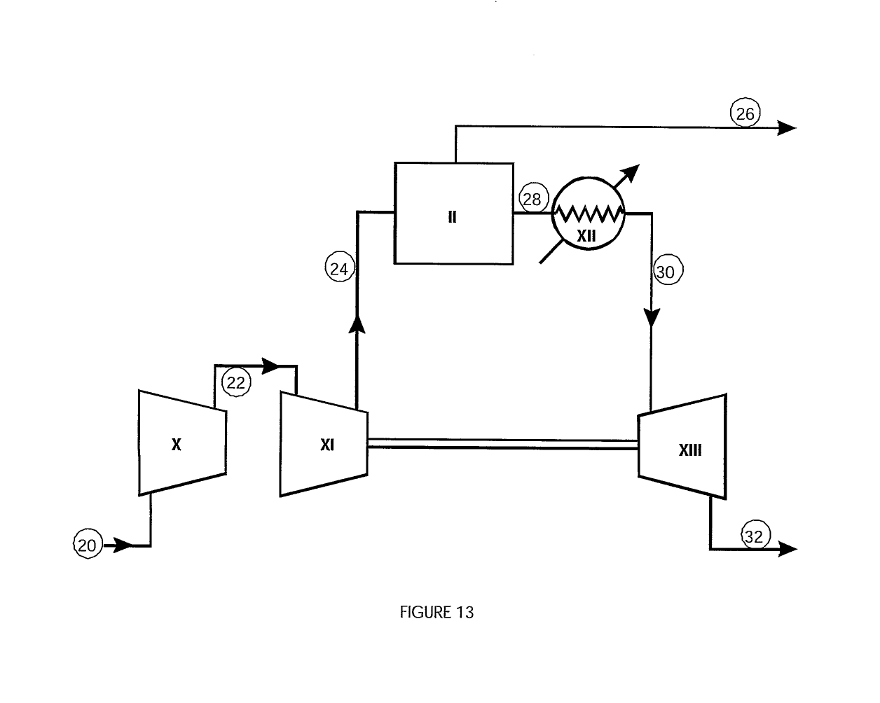

Those skilled in the art will recognise that best operating pressure for the CO₂ removal does not necessarily equate with best fired expander inlet pressure and vice versa, and also that standard compression machinery may also not be conducive to best CO₂ removal plant pressure. FIG. 13 depicts a means of overcoming these difficulties. In this example a nominal 100 mol/h of flue gas (Stream 20) which has been compressed to 17.5 bar (Stream 22) by a standard machine (X) is then compressed to a pressure of 35 bar (Stream 24) in the compression side (XI) of a turbo-expander/compressor. The 35 bar gas is (Stream 24) subjected to CO₂ removal (II) and emerges (Stream 28) as 85.67 mol/h; the CO₂ leaving as stream 26. The treated gas (Stream 28) is then heated in heater XII to a temperature of 165° C. using low-grade heat e.g. from exhaust gas ducts, and the hot gas (Stream 30) is then expanded in a turbo expander (XIII) back to 17.5 bar/93° C. (Stream 32) and routed to the fired expander exhaust gas duct (III) to be further heated prior to entry into the fired expander. Under the above conditions the turbo-expander (XIII) and its connected compressor (XI) are in power balance. Higher preheat of the 35 bar gas will permit a higher expander outlet pressure, lower preheat will require a lower outlet pressure.

TABLE 1

| | STREAM | | | | | | | | | | | | | | |
|---|---|---|---|---|---|---|---|---|---|---|---|---|---|---|---|
| | 10 | 12 | 14 | 24 | 26 | 46 | 64 | 30 | 32 | 34 | 36 | 40 | 42 | 44 | 48 |
| GAS FLOW, | 100.00 | 84.40 | 84.40 | 137.78 | 137.78 | 15.63 | 84.40 | | | | | | | 15.63 | |
| kmol/h | | | | | | | | | | | | | | | |
| %, mol | | | | | | | | | | | | | | | |
| N₂ | 79.20 | 93.85 | 93.85 | 57.48 | 57.48 | | 93.85 | | | | | | | | |
| CO₂ | 17.33 | 2.05 | 2.05 | 40.00 | 40.00 | 100.00 | 2.05 | | | | | | | 100.00 | |
| O₂ | 3.47 | 4.10 | 4.10 | 2.52 | 2.52 | | 4.10 | | | | | | | | |
| LIQUID | | | | | | | | 19.93 | 19.93 | 52.53 | 19.93 | 32.6 | 32.6 | 32.6 | 32.6 |
| FLOW, | | | | | | | | | | | | | | | |
| m³/h | | | | | | | | | | | | | | | |
| CO₂ CONC, | | | | | | | | 0.845 | 0.845 | 0.063 | 0.063 | 0.063 | 1.699 | 1.22 | 1.22 |
| kmol/m³ | | | | | | | | | | | | | | | |
| PRESSURE, | 35 | 35 | 35 | 35 | 35 | 41 | 35 | 35 | 35 | 35 | 35 | 35 | 35 | 41 | 41 |
| bar | | | | | | | | | | | | | | | |
| TEMP, C. | 15 | 15 | 85 | 91 | 15 | 120 | 15 | 22 | 44 | 82 | 15 | 15 | 29 | 120 | 120 |

TABLE 2

| | STREAM | | | | | | | | | | | | | | |
|---|---|---|---|---|---|---|---|---|---|---|---|---|---|---|---|
| | 10 | 12 | 14 | 24 | 26 | 46 | 64 | 30 | 32 | 34 | 36 | 40 | 42 | 44 | 48 |
| GAS FLOW, | 100.00 | 61.22 | 61.22 | 137.55 | 137.55 | 38.78 | 61.22 | | | | | | | 38.78 | |
| kmol/h | | | | | | | | | | | | | | | |
| %, mol | | | | | | | | | | | | | | | |
| CO | 2.00 | 3.27 | 3.27 | 1.45 | 1.45 | | 3.27 | | | | | | | | |
| CO₂ | 40.00 | 2.00 | 2.00 | 56.38 | 56.38 | 100.00 | 2.00 | | | | | | | 100 | |
| H₂ | 58.00 | 94.73 | 94.73 | 42.17 | 42.17 | | 94.73 | | | | | | | | |
| LIQUID | | | | | | | | 23.7 | 23.7 | 56.3 | 23.7 | 32.6 | 32.6 | 32.6 | 32.6 |
| FLOW, | | | | | | | | | | | | | | | |
| m³/h | | | | | | | | | | | | | | | |
| CO₂ CONC, | | | | | | | | 1.699 | 1.699 | 0.063 | 0.063 | 0.063 | 2.404 | 1.214 | 1.214 |
| kmol/m³ | | | | | | | | | | | | | | | |
| PRESSURE, | 35 | 35 | 35 | 35 | 35 | 43 | 35 | 35 | 35 | 35 | 35 | 35 | 35 | 43 | 43 |
| bar | | | | | | | | | | | | | | | |
| TEMP, C. | 15 | 15 | 85 | 94 | 15 | 122 | 15 | 29 | 58 | 82 | 15 | 15 | 35 | 122 | 122 |

TABLE 3

| | STREAM | | | | | | | | | | | | | | |
|---|---|---|---|---|---|---|---|---|---|---|---|---|---|---|---|
| | 10 | 12 | 14 | 24 | 26 | 46 | 64 | 30 | 32 | 34 | 36 | 40 | 42 | 44 | 48 |
| GAS FLOW, | 100.00 | 35.71 | 35.71 | 165.00 | 165.00 | 64.29 | 35.71 | | | | | | | 64.29 | |
| kmol/h | | | | | | | | | | | | | | | |
| %, mol | | | | | | | | | | | | | | | |
| CH₄ | 35.00 | 98.00 | 98.00 | 21.21 | 21.21 | | 98.00 | | | | | | | | |
| CO₂ | 65.00 | 2.00 | 2.00 | 78.79 | 78.79 | 100.00 | 2.00 | | | | | | | 100 | |
| LIQUID | | | | | | | | 26.37 | 26.37 | 71.32 | 26.37 | 44.95 | 44.95 | 44.95 | 44.95 |
| FLOW, | | | | | | | | | | | | | | | |
| m³/h | | | | | | | | | | | | | | | |
| CO₂ CONC, | | | | | | | | 2.501 | 2.501 | 0.063 | 0.063 | 0.063 | 2.939 | 1.509 | 1.509 |
| kmol/m³ | | | | | | | | | | | | | | | |
| PRESSURE, | 35 | 35 | 35 | 35 | 35 | 54 | 35 | 35 | 35 | 35 | 35 | 35 | 35 | 54 | 54 |
| bar | | | | | | | | | | | | | | | |
| TEMP, C. | 15 | 15 | 85 | 96 | 15 | 122 | 15 | 35 | 52 | 82 | 15 | 15 | 37 | 122 | 122 |

TABLE 4

| | STREAM No. | | | | | | | | | | |
|---|---|---|---|---|---|---|---|---|---|---|---|
| | 1 | 2 | 3 | 4 | 5 | 7 | 8 | 11 | 12 | 13 | 14 |
| FLOW KG · MOL/H | 67267 | 84541 | 12115 | 72426 | 72426 | 17274 | 72426 | 1568 | 1568 | 73211 | 73211 |
| ANALYSIS, | | | | | | | | | | | |
| MOLE % | | | | | | | | | | | |
| N2 | 81.25 | 81.25 | | 94.84 | 94.84 | 81.25 | 94.48 | | | 93.83 | 93.83 |
| CO2 | 15.92 | 15.92 | 100.00 | 1.86 | 1.86 | 15.92 | 1.86 | | | 1.84 | 1.84 |
| H2O | | | | | | | | | | 2.14 | 2.14 |
| O2 | 2.83 | 2.83 | | 3.30 | 3.30 | 2.83 | 3.30 | | | 2.19 | 2.19 |
| H2 | | | | | | | | 100.00 | 100.00 | | |
| PRESSURE (bar) | 1 | 36 | 40 | 35.8 | 35.4 | 1 | 35 | 40 | 40 | 1.033 | 1.013 |
| TEMPERATURE C. | 15 | 15 | 15 | 50 | 200 | 15 | 750 | 15 | 200 | 250 | 100 |

STREAM 6 - COAL TO FBC IS 396 MWt (LHV)

TABLE 5

| | STREAM No. | | | | | |
|---|---|---|---|---|---|---|
| | 1 | 2 | 3 | 4 | 5 | 7 |
| FLOW KG · MOL/H | 67267 | 88470 | 12678 | 75792 | 75792 | 21203 |
| ANALYSIS, | | | | | | |
| MOLE % | | | | | | |
| N2 | 81.25 | 81.25 | | 94.84 | 94.84 | 81.25 |
| CO2 | 15.92 | 15.92 | 100.00 | 1.86 | 1.86 | 15.92 |
| H2O | | | | | | |
| O2 | 2.83 | 2.83 | | 3.30 | 3.30 | 2.83 |
| H2 | | | | | | |
| PRESSURE (bar) | 1 | 36 | 40 | 35.8 | 35.4 | 1 |
| TEMPERATURE C. | 15 | 15 | 15 | 50 | 320 | 15 |

| | STREAM No. | | | | | | |
|---|---|---|---|---|---|---|---|
| | 8 | 9 | 10 | 11 | 12 | 13 | 14 |
| FLOW | 75792 | 75792 | 75792 | 1642 | 1642 | 76613 | 76613 |
| KG · MOL/H | | | | | | | |
| ANALYSIS, | | | | | | | |
| MOLE % | | | | | | | |
| N2 | 94.48 | 94.48 | 94.48 | | | 93.83 | 93.83 |
| CO2 | 1.86 | 1.86 | 1.86 | | | 1.84 | 1.84 |
| H2O | | | | | | 2.14 | 2.14 |
| O2 | 3.30 | 3.30 | 3.30 | | | 2.19 | 2.19 |
| H2 | | | | 100.00 | 100.00 | | |
| PRESSURE | 35 | 14.5 | 14.2 | 40 | 40 | 1.033 | 1.013 |
| (bar) | | | | | | | |
| TEMPERATURE | 750 | 565 | 750 | 15 | 200 | 370 | 100 |
| C. | | | | | | | |

STREAM 6 - COAL TO FBC IS 472 MWt (LHV)

1. A process for at least partly regenerating a first absorption solvent stream loaded with a component X; comprising the following steps:
a) contacting a feed gas stream with a lean second absorption solvent stream thereby producing a rich second solvent stream and a stripping gas stream that has a lower concentration of X than said feed gas stream;
b) heating at least part of said rich second solvent stream before or during contacting it with a part of said stripping gas stream to produce a regenerated second solvent stream; and
c) regenerating the loaded first solvent stream by contacting this stream with a further part of said stripping gas stream to yield a regenerated first solvent stream.

2. A process according to claim 1 wherein during step (b) the rich second solvent stream is heated by up to 100° C., or by up to 60° C., or by up to 30° C.

3. A process according to claim 1 wherein the first loaded solvent stream and/or the rich second solvent is regenerated at a pressure in the range 10 bar to 100 bar, or 25 bar to 100 bar.

4. A process according to claim 1 wherein said regenerated first solvent stream is contacted with a gas stream rich in X to yield a gas stream with a reduced concentration of X and a first solvent stream rich with a component X from/to which said first solvent stream loaded with component X is derived/corresponds.

5. A process according to claim 4 wherein the first solvent stream rich in X is heated, without depressurization, by a temperature up to 100° C., or by up to 120° C., to produce the partly regenerated first solvent stream loaded with component X and a gas stream rich in X.

6. A process according to claim 5 wherein the first solvent stream rich in X is pumped to a substantially higher pressure before being heated.

7. A process according to claim 6 wherein the substantially higher pressure corresponds to a pressure increase in the range 2 to 50 bar, or in the range 5-25 bar.

8. A process according to claim 4 wherein the said contacting yields directly said first stream loaded with component X and where the gas stream rich in X is provided by taking at least part of the gas produced by the regeneration steps (b) and/or (c) and partly removing component X by liquefaction.

9. A process for removing CO₂ from a feed gas comprising the following steps:
(a) chilling at least part of said feed gas, at a pressure of at least 10 bar to condense and partially remove CO₂ as a liquid at high pressure for export and thereby produce a CO₂-lean gas stream;
(b) passing at least part of said CO₂-lean gas stream to a contactor where further CO₂ is removed, by absorption in a solvent stream lean in CO₂ to produce a product gas stream and a solvent stream rich in CO₂; and
(c) passing said solvent stream rich in CO₂ to a high pressure regenerator where the solvent is stripped with a stripping gas to produce a CO₂ rich gas stream at pressure and a CO₂-lean solvent stream; from which said solvent lean in CO₂ is subsequently derived.

10. A process according to claim 9 wherein the solvent stream rich in CO₂ is at least partly regenerated at high pressure (without prior expansion) through heating by up to 100° C.₅ or by up to 60° C., or by up to 30° C. before or during contacting it with a part of said stripping gas stream.

11. A process according to claim 9 wherein at least part of the said CO₂ rich stream is mixed with said feed gas prior to step (a) and thus recycled.

12. A process according to claim 9 wherein the solvent stream rich in CO₂ is heated prior to or within said regenerator.

13. A process according to claim 9 further comprising a single stage or multiple stage expansion-compression refrigeration plant that provides at least part of said chilling during step (a) and where at least part of the cold in the condensed liquid is used to chill a refrigerant stream used in the refrigeration plant prior to expansion in at least one stage of the refrigeration plant.

14. A process for separating CO₂ from a flue gas, produced by the combustion of a fuel, which also generates shaft power comprising the following steps:
(a) compressing said flue gas and at least part of the cooled flue gas of step (e), to a pressure of at least 6 bar, to form a compressed mixed flue gas stream;
(b) removing at least 60% of the CO₂ in the compressed mixed flue gas stream using a gas separation process to yield a low CO₂ content gas at a pressure of at least 5 bar;
(c) heating said low CO₂ content gas indirectly using a fired heater fuelled by the combustion of a carbonaceous fuel;
(d) expanding the heated low CO₂ content gas produced by step (c) in a gas turbine to yield shaft power; and
(e) cooling the flue gas produced by combusting said carbonaceous fuel in step (c).

15. A process according to claim 14 wherein the gas separation process of step (b) is a physical absorption process that produces a solvent stream rich in CO₂ which is at least partly regenerated at high pressure (without prior expansion) through heating by up to 100° C., or by up to 60° C., or by up to 30° C. before or during contacting it with a part of a stripping gas stream

16. A process according to claim 14 wherein the gas separation process of step (b) uses a liquid solvent to remove CO₂ by absorption and so produce a loaded solvent; and wherein at least 30 to 70% of the loaded solvent is regenerated at a pressure of at least 5 to 15 bar, or 15 to 30 bar, or 25 to 50 bar.

17. A process according to claim 14 wherein in step (a) said flue gas and at least part of the cooled flue gas of step (e), is compressed to a pressure of at least 15 to 30 bar or 25 to 50 bar, to form the compressed mixed flue gas stream.

18. A process according to claim 14 wherein after step (c) a fuel gas is injected into the heated low CO₂ content gas and combusted therein to further raise the temperature of the resulting stream, prior to step (d).
